(19) United States
(12) Patent Application Publication
(10) Pub. No.: US 2008/0248279 A1
(43) Pub. Date: Oct. 9, 2008

(54) PAPER MACHINE FABRICS

(76) Inventors: SANJAY PATEL, Summerville, SC (US); Robert Crook, Wilson, NC (US)

Correspondence Address: TAYLOR & AUST, P.C., P.O. Box 560, 142. S Main Street, Avilla, IN, 46710, US

(21) Appl. No.: 11/696,439

(22) Filed: Apr. 4, 2007

(51) Int. Cl. B32B 27/40; B32B 3/26; B32B 27/18

(52) U.S. Cl. 428/304.4; 427/331; 428/323; 428/319.3; 428/319.7; 428/423.1

(57) ABSTRACT

A composite paper machine fabric substrate of a base and batt formed from polyamide is reinforced by a polymer having a glass transition temperature (TG) of −40 to 15° C. that is dispersed at below the face side surface of the fabric substrate to mechanically bond to the substrate. The polymer is thermoplastic enabling an improvement in flexibility and overall wear while at the same time permitting porosity necessary for proper drying of paper.

### BACKGROUND OF THE INVENTION

1. Field of the Invention

The present invention relates to paper machine fabrics, and, more particularly, to the reinforcement of said fabrics and the methods of reinforcing them.

2. Description of the Related Art

The papermaking process generally includes the steps of making a slurry of fibrous material. The source of fiber may be, e.g. wood fiber in the form of virgin fibers or recycled fiber. The slurry is formed into a matted sheet that is initially dewatered. The matted sheet is pressed to continue the dewatering process and to give the sheet that is a desired texture. The sheet is finally further dried, as appropriate, to remove any remaining excess water. As a result, the papermaking machine usually includes a forming section, a press section, and a dryer section.

The forming section of papermaking usually includes the preparation of a pulp slurry. This slurry is carried through the forming section of the papermaking machine on a forming fabric, similar to a porous conveyor belt, where the pulp slurry can be formed into a sheet. The sheet can be formed and then transported to the press section of the papermaking machine where the process of removing water from the sheet can be continued.

In the press section of the papermaking machine, the matted sheet of paper fibers can be transported on one or more press fabrics and can be passed through rollers or drums along with the press fabrics such that in a press nip, at least some of the additional water can be squeezed out of the sheet and absorbed through the porous press fabric. As compression is increased between the rollers, water removal can also be increased. Pressing can also consolidate the sheet and provide texture to the surface of the sheet as appropriate.

The press felt or fabric is in the general category of paper machine clothing (PMC). This designation broadly describes a class of fabrics that are used for industrial purposes such as press felts for transporting material in the paper machine process. The desirable qualities of such felt or fabric can include resistance to abrasion, compaction, heat and chemical in addition to having strength permeability and caliber retention (consistent thickness). For purposes of this disclosure, the term press felts or press fabrics as used herein, refer to those fabrics that can be used in the press section of a papermaking machine to support and transport a formed sheet of paper fibers to the dryer section of the papermaking machine where additional water can be removed.

Press felts usually include a base fabric (for example a woven or non-woven cloth) that can have a staple fiber batt overlying it to for a face side, or sheet side for the fabric. The staple fiber batt can be needle punched to the base fabric in order to secure it. In many press felts, multiple layers of batt fibers can be needle punched to the face or paper side of the base fabric. The base fabric of press felts can, for example, be made of all synthetics, primarily nylon polymers, although polyester and other materials can be utilized. Preferably, the base substrate and batt fiber can be made from polyamide.

It will be appreciated that the term base fabric is used herein refers to the underlying substrate of the press felt and can include scrim and composite structures as well as woven and non-woven fabrics known in the art as being suitable for use in press felts for papermaking machinery. The base fabric can be woven or otherwise constructed with cable monofilaments, plied multifilaments, spun yarns or single monofilaments. Base fabrics can be utilized in a single layer or multi-layer mesh, and can be woven as endless belts or woven flat and joined with seams. The weave of the base fabric can be constructed to affect pressure uniformity, flow resistance, void volume and compression properties. The base fabrics can be classified as conventional (endless) designs, stratified (laminated) designs and seam fabrics. The monofilaments or fibers used in the structures can be round in cross-section, flat monofilaments, and hollow monofilaments. Alternatively, the base fabric can be a scrim (an extruded netting) or a composite structure such as an extruded spun bonded sheet.

The batt may be made from appropriate material such as nylon fibers or other synthetic materials having, for example, a round cross-section.

For the purpose of this disclosure, the term “batt” refers to any kind of assembly or web of fibers other than the base fabric which is suitable for use in press felt and not necessarily limited to conventional batting. The fibers can be carded into a uniform web to form the batt before being needle punched into the base fabric, for example in a series of layers. In addition the batt fibers can be needle punched into the base fabric with the fibers oriented in the cross machine direction (CMD) or in the machine direction (MD), although alternative methods for needle punching may be employed. The needling press can be engineered to affect the density, surface properties, and permeability of the press fabric.

Press felts can be prone to surface wear. This is especially true when the batt structure of the fabric can be stratified and a finer dtex (decitex—a measuring unit for the mass of yarn in grams per 1000 meters) fiber can be utilized on the surface of the fabric to form a fine cap layer with coarser layers of fiber underneath. It is difficult to needle punch the fine cap layer into the coarse underlay effectively to be both strong and wear resistant, as well as keeping the fine fiber on the face side surface in a homogeneous layer to provide sheet support, enhance dewatering and, make the sheets smoother, and the like. Finer detex fibers, at times, are inherently weak. Resin treatments and low melt binding of fibers can be utilized to reinforce these weak fine diameter surface fibers. However, the presence of these elements can change the openness, porosity, density, and flow properties of the surface of the fabric which can result in reduced performance. Problems with prior art low melt binding of the fibers can be a very poor physical and chemical property after the melting. They may also experience brittleness and cannot be reversibly thermally formed.

Thus, the need exists in the art for a improved apparatus and method for enhancing the face side surface of a felt or fabric used in the paper making process.

### SUMMARY OF THE INVENTION

The invention, in one form, is directed to a paper machine fabric having a porous composite fabric substrate. A polymer having a glass transition temperature (TG) of between about −40 Celsius (° C.) and about 15° C. overlies the face side of the fabric substrate. The polymer is dispersed at least partially below the face side surface of the fabric substrate to mechanically bond to the substrate.

The invention, in another form, is directed to a method of improving the face side surface of a porous composite substrate of a paper machine fabric. The method includes the steps of applying to the face side surface of the substrate a layer of polymer having a glass transition temperature (TG) of between about −40° C. and about 15° C. in a form having sufficiently low viscosity that the polymer can be dispersed at least partially below the space side surface of the substrate. The polymer is forced into the substrate so that it wets and mechanically bonds to the substrate.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 shows a greatly enlarged cross-section of a fabric embodying the present invention;

FIG. 2 shows a greater enlargement of the cross-section of the fabric of FIG. 1 adjacent the upper face side surface; and

FIGS. 3-4 show enlarged plan views of various surface areas of the fabric of FIG. 1.

Corresponding reference characters indicate corresponding parts throughout the several views. The exemplifications set out herein illustrates one embodiment of the invention and such exemplification is not to be construed as limiting the scope of the invention in any manner.

### DETAILED DESCRIPTION OF THE INVENTION

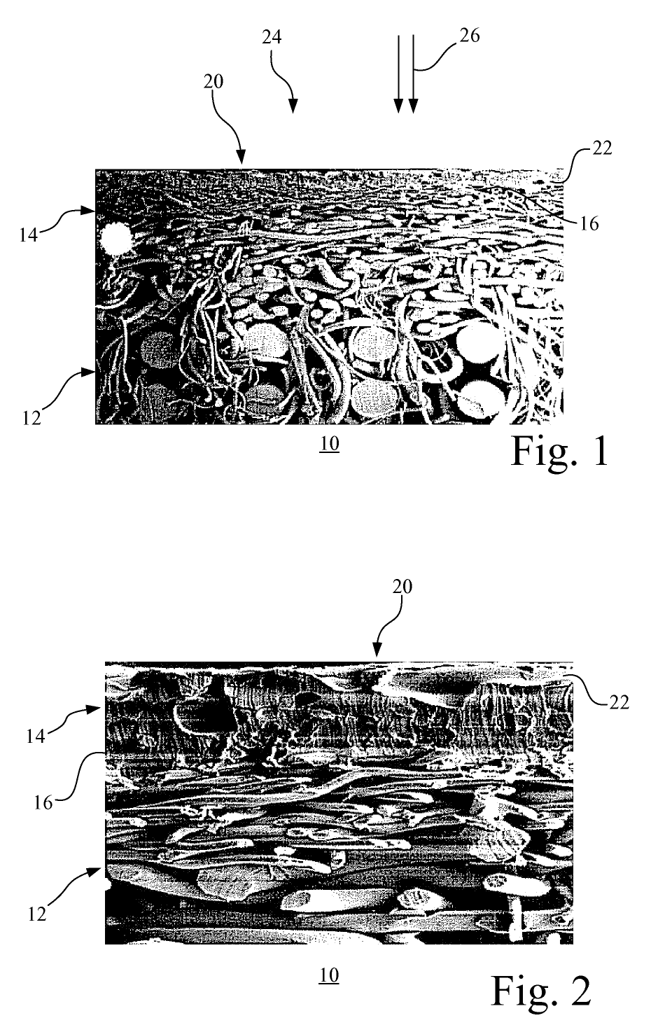

Referring now to the drawings, and more particularly to FIG. 1, there is shown the cross-section of a press felt or fabric generally indicated by reference character 10. This fabric may be utilized for transporting a sheet of fibrous material through the press section of a papermaking machine. The fabric 10 can take various forms of press felts such as batt-on-base felts, baseless felts, batt-on-mesh felts, felts with no crimp base fabric, composite fabrics, and laminated (stratified) press felts.

The press fabric 10 may include a base fabric and one or more layers of an assembly of fibers such as batt 14 securely attached to the base fabric 12 by means of needle punching using needle punching apparatus well known in the art. Additional layers such as a surface layer may be secured to the base fabric and the batt 14 also by needle punching. When only one layer of fibers is employed it can be needle punched into the interface 16 between the base fabric 12 and the batt 14. In this form, the batt has one face 20 serving as the face side of the press felt 10. The face side 20 serves as a porous support for fibrous material (not shown) used in the paper making process.

Additional layers of batt fibers can be employed as needed. The additional layers can be needle punched into the face side 20 of batt 14 as appropriate. Various methods of application may be employed to sufficiently and securely attach the assembly of fibers 14 to the base fabric 12.

The base fabric 12 can be woven (except for no crimp base fabrics) or formed as a composite and can be made from a variety of methods known in the art. For example, the fabric 12 may be a single layer or multi-layer mesh, and can be woven as an endless belt or woven flat and joined later in the manufacturing process. The base fabric 12 may also be woven in a number of alternative manners to manipulate and otherwise provide particular characteristics and properties for the base fabric. As an example the fabric can be stratified or laminated with additional fabrics on its surface to create further layers so that one or more layers of fabric can be employed.

The base fabric 12 and the batt 14 may be constructed from any suitable material known in the art for press fabric. The base fabric 12 can be made of all synthetics, although wool may be also employed, polyamide polymers are preferable, but the base fabric may also be made from polyester, polyphenylene sulfide or other similar materials. Polyamide polymers usually have greater resistance to compaction in the press nip compared to polyester and may be more abrasion resistant and tougher. The base material may be formed from cabled monofilaments, plied multi-filaments, spun yarns, and/or single monofilaments. Each type of fiber has properties that influence operational characteristics of the press felt 10 and are chosen based on the desired characteristics of the fabric. As an example, multi-filaments can be more durable and have higher elongation than monofilaments but can be more compressible and less resistant to chemical attack.

As is well known to those skilled in the art, the term batt, as used herein, refers not only to a soft bulky bundle of fibers forming a layer on the interface 16 of the base fabric 12, but covers any other type of assembly of fibers, be they woven or non-woven, carded or not-carded, and fibers suitable for use in the press section of a papermaking machine. The fibers forming the batt 14 may be non-woven and made from all synthetics. A preferred material is polyamide, but polyester and polyphenylene sulfate may also be employed.

In accordance with the present invention, a layer of material 22 is applied to the face side surface 20 of the press fabric to improve performance of the fabric 10. The material 22 is formed from a thermoplastic elastomer, in either yarn, film particle or other solid form, to the fabric 10 and more specifically the batt 14. The thermoplastic elastomer 22 is a polymer having a glass transition temperature (TG) of between about −40 Celsius (° C.) and about 15° C. The glass transition temperature is a temperature above which an amorphous material behaves more like a liquid, as in a rubbery state. The layer 22 may be heated to a sufficiently low viscosity and pressed into the fabric 10 by the application of heat, represented by wavy lines 24 and the application of pressure represented by multiple arrows 26 so that it wets and mechanically bonds to the substrate material. It should be apparent to those skilled in the art that the heat and pressure may be applied by a variety of equipment and methods.

FIG. 2 shows an even greater enlargement of the cross-section of the fabric 10 showing the material 22 on the face surface 20. Because the material 22 is thermoplastic, it flows into, wets and bonds to the substrate fibers and yams so that the resultant material is characterized by physical, rather than chemical cross links. This in turn, permits reversible forming capability to create new structures without loss of inherent properties of the material. The preferred material would be polyether thermoplastic urethane, but any elastomer having the characteristic glass transition temperatures (TG) specified above may be employed. It is also contemplated that a stabilizer may be included in the material 22. The particles may be in particulate form having sizes preferably between about 50 and 100 microns but larger and smaller particles are feasible to permit fiber bonding and permeability characteristics of the finished fabric. A hardness range of about 70 A to about 50 D Shore is feasible with the preferable values being about 80 A to about 95 A. The Shore® hardness scale is commonly used to measure the hardness of plastics and elastomeric materials. The Shore A scale is used for softer materials with a higher number indicating greater relative hardness. The Shore D scale is used to indicate the hardness of “harder” materials.

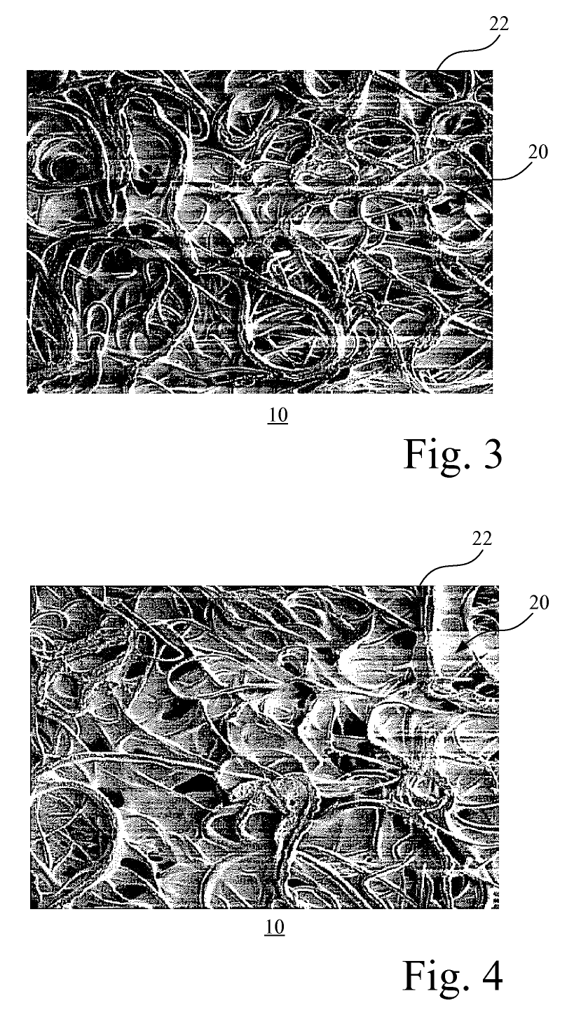

The resultant belt press fabric 10 has a thermal formed integrated layer 22 that allows dispersion into the base substrate to promote increased fiber bonding as particularly shown in FIGS. 2-4. In addition, it enables increased smoothness by smoothing out needle tracking and non-uniformities on the surfaces may be possible, while maintaining a density gradient. The structure improves the wear resistance and dewatering can be improved through controlled pore size and distribution. This process may be applied to fabrics set forth and described in application International Patent Publication WO 2004/085727 of common ownership with the present application, the disclosure of which is hereby incorporated in its entirety.

The end use of the resultant material, preferably is for press fabrics but it can also be used with advantage for needle dryers, industrial and filter fabrics and transfer belts. The startup of a paper machine incorporating the fabric is improved because the modified surface has increased surface density and elasticity. The fiber loss occurring through chemical attack on prior art PMC through chemical additives in the paper or by the cleaning chemicals for the paper are resisted to a greater extent.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A paper machine fabric comprising:
a porous composite fabric substrate having a face side; and
a polymer having a glass transition temperature (TG) of between about −40 degrees Celsius (C) and about 15° C. overlying the face side of said fabric substrate, said polymer being dispersed at least partially below the face side surface of said fabric substrate to mechanically bond to said fabric substrate.

2. A paper machine fabric as claimed in claim 1, wherein said polymer has a Shore hardness of about 70 A to about 50 D.

3. A paper machine fabric as claimed in claim 1, wherein said polymer has a Shore hardness of about 80 A to about 95 A.

4. A paper machine fabric as claimed in claim 1, wherein said polymer is an elastomer.

5. A paper machine fabric as claimed in claim 4, wherein said polymer is a thermoplastic elastomer.

6. A paper machine fabric as claimed in claim 5, wherein said thermoplastic elastomer is a polyether urethane.

7. A paper machine fabric as claimed in claim 1, wherein said polymer has a stabilizer dispersed therein.

8. A paper machine fabric as claimed in claim 7, wherein said stabilizer comprises particles.

9. A paper machine fabric as claimed in claim 8, wherein the particle size is between about 50 microns and about 100 microns.

10. A paper machine fabric as claimed in claim 1, wherein said porous composite fabric comprises a base and a batt overlying said base and secured thereto, said batt being the face side of said fabric.

11. A paper machine fabric as claimed in claim 10, wherein said batt is needled to said base.

12. A paper machine fabric as claimed in claim 1, wherein said porous composite fabric is formed from polyamide.

13. A method of improving the face-side surface of a porous composite fabric substrate comprising the steps of:
applying to the face-side surface of said fabric substrate a layer of polymer having a glass transition temperature (TG) of between about −40 degrees Celsius (° C.) and about 15° C. in a form having sufficiently low viscosity that said polymer can be dispersed at least partially below the face-side surface of said fabric substrate; and
forcing said polymer into said fabric substrate so that it wets and bonds to said fabric substrate.

14. A method as claimed in claim 13, wherein said polymer is forced into said fabric substrate by contact pressure.

15. A method as claimed in claim 14, further comprising the step of heating said polymer to cause it to bond to said fabric substrate.

16. A method as claimed in claim 13, wherein the Shore hardness of said polymer is between about 70 A and about 50 D.

17. A method as claimed in claim 13, wherein the polymer has a Shore hardness of about 80 A to about 95 A.

18. A method as claimed in claim 13, wherein said polymer is an elastomer.

19. A method as claimed in claim 18, wherein said polymer is a thermoplastic elastomer.

20. A method as claimed in claim 19, wherein said thermoplastic elastomer is a polyether urethane.

21. A method as claimed in claim 13, wherein a stabilizer is applied to said polymer prior to dispersion in said fabric substrate.

22. A method as claimed in claim 21, wherein said stabilizer comprises particles dispersed within said polymer.

23. A method as claimed in claim 22, wherein the particle size of said stabilizer is between about 50 microns and about 100 microns.

24. A method as claimed in claim 13, wherein said substrate comprises a base and a batt overlying said base to form the face side of said substrate.

25. A method as claimed in claim 24, wherein said batt is needled into said base to secure it thereto.

26. A method as claimed in claim 13, wherein said composite substrate is formed from polyamide.
